(19) United States
(12) Patent Application Publication
(10) Pub. No.: US 2003/0135817 A1
(43) Pub. Date: Jul. 17, 2003

(54) Automated method, system and software for storing data in a general format in a global network

(75) Inventor: Timothy Allen Shear, Novi, MI (US)

Correspondence Address: FOLEY AND LARDNER, SUITE 500, 3000 K STREET NW, WASHINGTON, DC, 20007, US

(73) Assignee: G.E. INFORMATION SERVICES, INC.

(21) Appl. No.: 10/042,260

(22) Filed: Jan. 11, 2002

(51) Int. Cl. G06F 15/16

(52) U.S. Cl. 715/500; 715/530

(57) ABSTRACT

An automated method, system and software for storing and transmitting data in an universal format in a global network. A document is received in a first format, is parsed into constituent node sets. The node sets are each semantically-tagged, indexed and stored in a data store. The document in the first format is reassembled into a second format.

### FIELD OF INVENTION

This invention relates generally to the field of automatically transferring data between endpoints in a network, and more particularly, to a method, system and software for storing documents so that they can be indexed and reformatted into various target document types.

### BACKGROUND OF THE INVENTION

Data interchange systems allow communication between computer systems with different data structures. A computer system that processes data having a first data structure is able to communicate with at least one other computer system adapted to process data having a second and different data structure or format using a data interchange system. The data interchange system translates data having a first data structure into a target data structure format, which is communicated to the target computer system. Moreover, while these prior data interchange systems have allowed for the transformation between different data structures, they still have several drawbacks.

Most prior systems use a “dictionary structure technique.” This technique requires that each received message be separated into a fixed number of hierarchical levels. Each of these hierarchical levels is associated with a separate dictionary. Each dictionary is then used to translate the data structure level into a corresponding target structure. One problem with this technique is that sometimes the message format that is being separated into a number of hierarchical levels requires more levels than there are different types of dictionaries. In this case, the message is not properly translated, and the system fails.

Moreover, these dictionaries have fixed formats. In the art, there is no known universal language that may be used with any variety of formats. The prior interchange systems are not capable of accepting or translating new or foreign types of formatted messages.

Moreover, a problem with the prior art is that there is no known way to store documents so that they can be stored, queried, tracked, and reformatted into various target document types. Further, there is no way for these documents to be accessed from various trading partners in a commerce network.

One known solution is to store relevant information in a relational database management system (RDBMS). In the world of e-commerce, the Internet and the World Wide Web, the fluidity of information makes this approach problematic. When there is a new data representation in a new format or a new scheme, the system becomes unmanageable and the system fails because the RDBMS structure is not well-suited for storing new data representations.

Therefore, there is a need for the storing and reformatting of documents transmitted within a network configured to provide commerce functions on a global scale between trading partners. Also, there is a need to track and report the status of transactions represented by the documents passed between trading partners in a commerce network.

### SUMMARY OF THE INVENTION

In one aspect, the present invention provides a computer implemented method of automatically storing and transmitting data in a network in an universal format, the method comprising: receiving a document in a first format; parsing the received document in the first format into constituent node sets; and semantically-tagging, indexing and storing the each node set of the received document in a data store.

In another aspect, the present invention further comprises retrieving the each node set of the received document and reassembling the required node sets of the received document into a second format.

In one aspect of the present invention, the node sets comprise information couplets.

In another aspect of the present invention, the node sets are stored in a data store.

In yet another aspect of the present invention, the node sets are stored in a format that can be translated to substantially any other format.

In another aspect of the present invention, the stored node sets are stored in a format corresponding to a format of the data store.

In one aspect, the present invention further comprises triggering a propagation of a predetermined event to an endpoint of said network by the storing of a node set in said data store.

In yet another aspect of the present invention, an endpoint in the network registers with the network for notification of the propagation of said predetermined event in the network.

In another aspect, the present invention further comprises: receiving a second document; parsing the received second document into constituent node sets; indexing each node set of the received second document; storing each node set of the received second document in the data store; and updating at least one of the node sets of the document previously stored in the data store which corresponds to one of the node sets of the received second document.

In yet another aspect, the present invention further comprises triggering a propagation of an event to an endpoint of the network by the storing of at least one of the node sets of the second document and updating at least one of the node sets of the document previously stored in the data store.

In another aspect of the present invention, the endpoint retrieves the node sets stored in the data store upon the notification of the predetermined event.

In yet another aspect, the present invention further comprises: receiving a second document; parsing the received second document into constituent node sets; indexing the each node set of the received second document; storing the each node sets of the received second document in the data store; and appending at least one of the node sets of the received second document to the document previously stored in the data store.

In another aspect, the present invention further comprises triggering a propagation of an event to an endpoint of the network by the storing or appending of at least on of the node sets of the second documents stored in the data store.

In a further embodiment, the present invention provides a system for automatically storing and transmitting data in a network in an universal form, the system comprising: a data translator that receives a document in a first format, said data translator comprising: a parser that parses the received document into constituent node sets; and a semantic tagging unit that semantically tags each constituent node set; an indexer that indexes the node sets; and a data store that stores each indexed node set.

In another embodiment, the present invention provides a computer program product having program code that is executable by a computer for storing and transmitting data in a network in an universal form, the program code configured to cause the computer to perform the following steps: receiving a document in a first format; parsing the received document in the first format into constituent node sets; and semantically-tagging, indexing and storing the each node set of the received document in a data store.

In another embodiment, the present invention provides a computer implemented method of automatically storing and transmitting data in a network in an universal form comprising the steps of: receiving a document in a first format; parsing, semantically-tagging, storing, and indexing the node sets of the received document in the first format; and reassembling the each node set into a second format.

In another embodiment, the present invention provides a system for automatically storing and transmitting data in a network in an universal form, the system comprising: means for receiving a document in a first format; means for parsing the received document into constituent node sets; means for semantically-tagging the each node set; means for indexing the each node set; and means for storing the each indexed node set.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a schematic block diagram showing the components of a general purpose computer system connected to an electronic network.

FIG. 2 is a block diagram showing the system components of a preferred embodiment of the present invention.

FIG. 3 is a block diagram showing the system components of a data translator used in the preferred embodiment of the present invention.

FIG. 4 is a flow chart illustrating a preferred embodiment of the method steps according to a preferred embodiment of the present invention.

FIG. 5A is a diagram illustrating an example of a preferred embodiment of the method of translating a document in a first format into a canonical format.

FIG. 5B is a diagram illustrating an example of a preferred embodiment of the method of translating a document stored as node sets to a document in a second format.

FIG. 6 is a flow chart illustrating a preferred embodiment of the method steps according to a preferred embodiment of the present invention.

### DETAILED DESCRIPTION OF THE INVENTION

To facilitate understanding of the present invention, the following definitions are provided:

Definitions:

Global Commerce Network (GCN): a network configured to provide commerce functions on a global scale between trading partners. Typical commerce functions include: trade represented by invoices, purchase orders, stock (inventory) level queries; financial services such as settlements; logistics such as transportation, storage and warehousing, fulfillment; and other functions required for commerce between trading partners.

Semantically-tagged node set: a set of nodes representing parsed values within a received document where values of like semantic distinction are tagged with their semantic tag to form nodes. The nodes derived from a document are collected to form a node set.

Global Data Store (GDS): the globally-accessible data storage repository of the resultant node sets of documents received by the Global Commerce Network. This repository may be hosted by a GCN provider and be accessible, within privilege constraints, by all network-connected partners.

Trading Partner: any component or device that a user may exchange commercial data or information with. The endpoints of the GCN.

Canonical: a prescribed single format conforming to established rules or patterns, as of procedure.

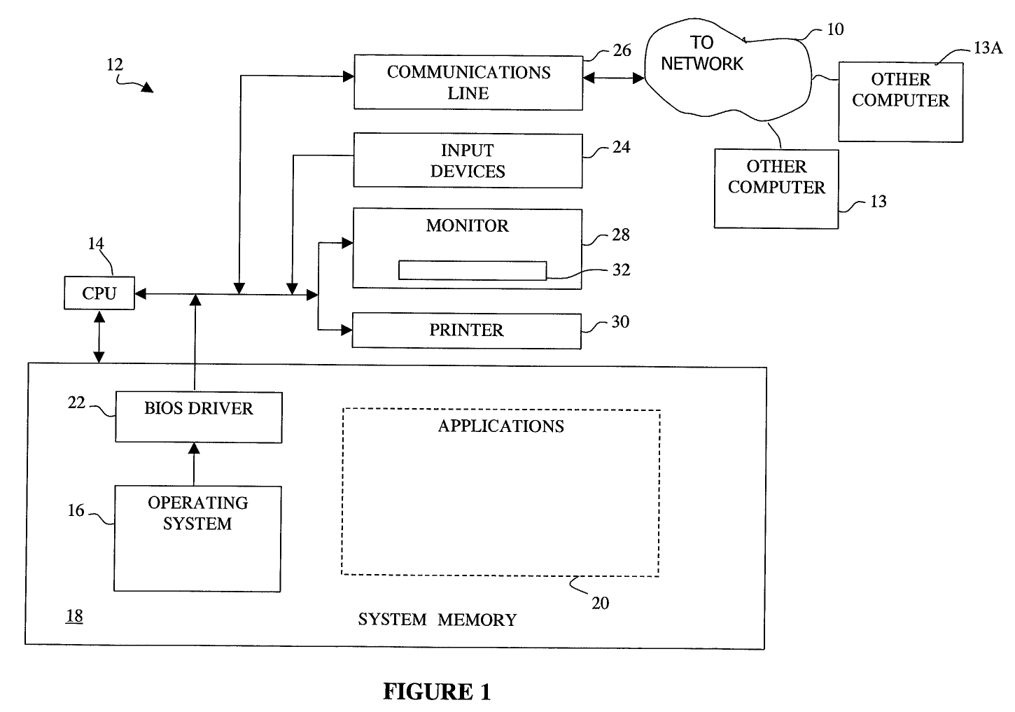

With reference to the figures, FIG. 1 is a block diagram showing the components of a general purpose computer system 12 connected to an electronic network 10, such as a computer network. The computer network 10 can also be a public network, such as the Internet or Metropolitan Area Network (MAN), or other private network, such as a corporate Local Area Network (LAN) or Wide Area Network (WAN), or a virtual private network. As shown in the FIG. 1, the computer system 12 includes a central processing unit (CPU) 14 connected to a system memory 18. The system memory 18 typically contains an operating system 16, a BIOS driver 22, and application programs 20. In addition, the computer system 12 contains input devices 24 such as a mouse and a keyboard 32, and output devices such as a printer 30 and a display monitor 28.

The computer system generally includes a communications interface 26, such as an Ethernet card, to communicate to the electronic network 10. Other computer systems 13 and 13A may also be connected to the electronic network 10. One skilled in the art would recognize that the above system describes the typical components of a computer system connected to an electronic network. It should be appreciated that many other similar configurations are within the abilities of one skilled in the art and all of these configurations could be used with the methods of the present invention.

In addition, one skilled in the art would recognize that the “computer” implemented invention described further herein may include components that are not computers per se but include devices such as Internet appliances and Programmable Logic Controllers (PLCs) that may be used to provide one or more of the functionalities discussed herein. Furthermore, the term “electronic” networks is intended to refer generically to the communications network connecting the processing sites of the present invention, including electronic implementations, but also encompassing optical or other equivalent technologies.

One skilled in the art would recognize that other system configurations and data structures and electronic/data signals could be provided to implement the functionality of the present invention. All such configurations and data structures are considered to be within the scope of the present invention.

One skilled in the art would recognize that in a Global Commerce Network (GCN), a network configured to provide commerce functions on a global scale between trading partners, there is a need for the storing and reformatting of documents transmitted within the network. Documents sent from one trading partner may have a different format than the format used by the receiving trading partner. The use of different formats amongst the sending and receiving trading partners (endpoints) causes complications.

Another problem occurs when transactions between trading partners are tracked, and status reports of such transactions are sent back to either the receiving trading partner, the sending trading partner, or a third party. Such transactions include purchase orders and invoices, for example.

A transaction is any exchange between trading partners, or the electronic record of the exchange. Third parties that may also have a part in the transaction may include shippers, financial institutions, and the government, for example.

In one aspect, the present invention provides that documents may be parsed and stored in a GDS in a format such that indexing in the future and retrieval into various unspecified formats is possible. This furthers the uncoupled interaction between trading partners. By eliminating the time dependency normally required in the transfer of documents between trading partners, the present invention further extends the ability of trading partners to participate in trade transactions over the GCN.

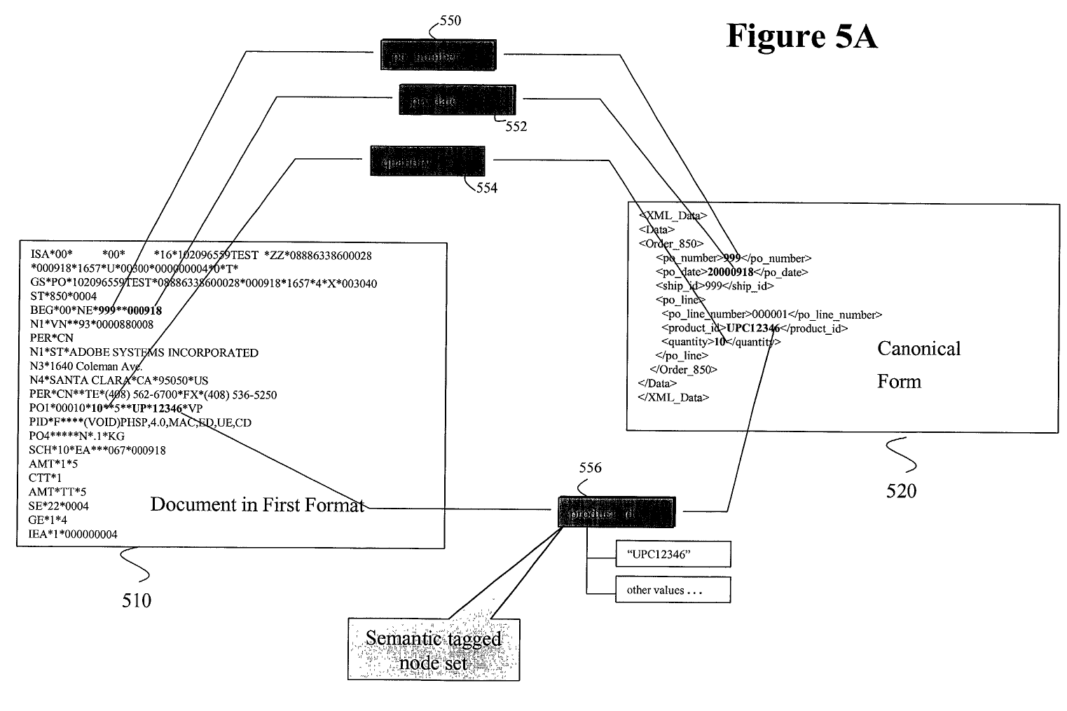

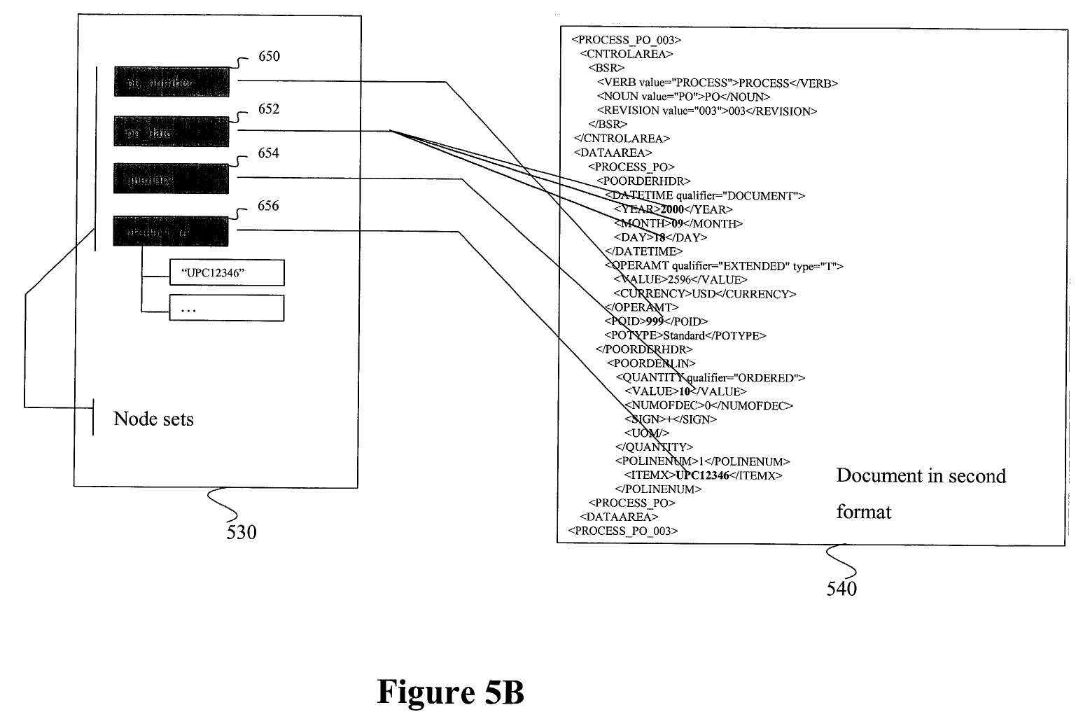

Another aspect of the present invention allows the GCN to store documents so that they can be stored, queried, tracked and reformatted into various target document types, so that these documents may be accessed by various partners. This is accomplished by storing documents in their “canonical” form in a database corresponding to the canonical form. The canonical form refers to a prescribed single format. In this regard, a document is essentially stored in two forms. The first format is in the canonical form as a canonical document. The second format is as a node set. A node is equivalent to an information couplet, where it comprises both the semantic tag and its corresponding value. A node set is a set of nodes of like semantic tags. For example, in reference to FIG. 5A, all the values under the semantic tag product_id 556, together with the semantic tag “product_id 556,” make up a node set, i.e., product_id 556 and UPC12346 and other values. Thus, the node set stores information couplets, where an information couplet includes a tag name and a value associated with that particular tag name.

The reformatting of documents in their canonical form is accomplished by taking the semantically-tagged value sets and outputting the nodes in a prescribed canonical form for the type of document in the GDS. Here they can be queried and retrieved by privileged parties. This prescribed canonical form is determined from and is dependent on the form of the document in a first format.

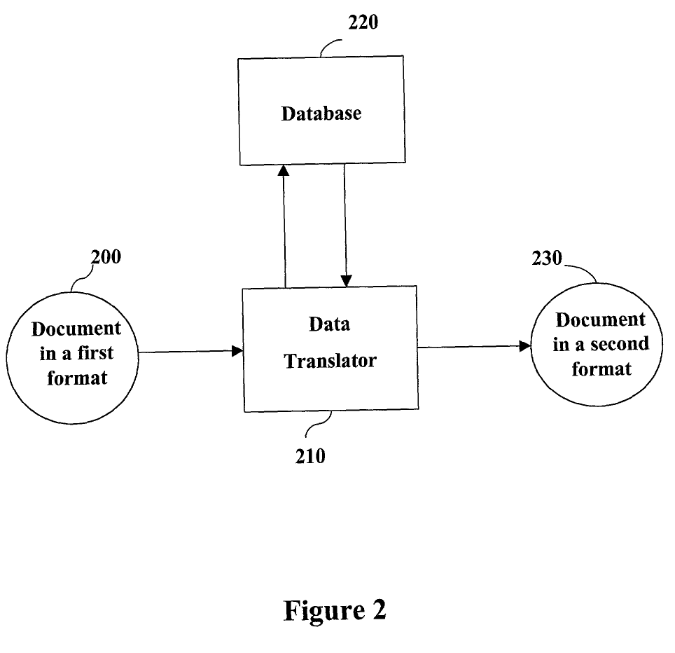

FIG. 2 illustrates the components of a preferred embodiment of the present invention. One skilled in the art would recognize other variations, modifications, and alternatives. The system provided by the present invention allows a document in a first format 200 to be stored and translated into a document in a second format 230 via a Data Translator 210.

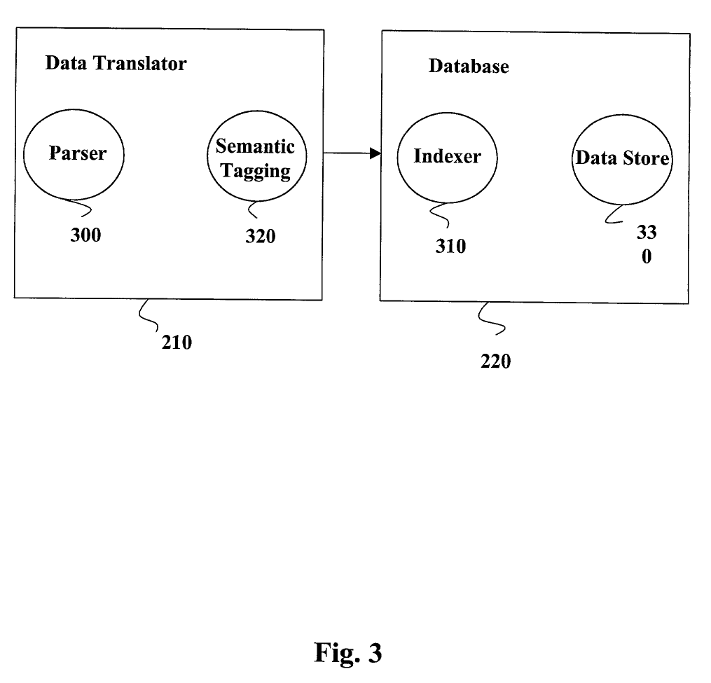

The document in the first format 200 is input into a Data Translator 210. The Data Translator 210, shown in further detail in FIG. 3, then outputs data into a Database 220, where the data is stored. Once the Database 220 returns the data to the Data Translator 210 at a later time, the document 200 is translated into a document of a second format 230, where the second format is the target format.

FIG. 3 illustrates the components of a preferred embodiment of the Data Translator 210 and the Database 220. One skilled in the art would recognize other variations, modifications, and alternatives.

In the preferred embodiment, the Data Translator 210 includes a Parser 300. The Parser 300 parses the documents in a first format 200 into semantically-tagged nodes, such as po₁₃ number 550, po_date 552, quantity 554, and product_id 556, shown in FIG. 5A, for example. In order to accomplish the semantic-tagging, a mapping of the document to its semantic equivalent must be performed. This may be done for the incoming document or may have been done previously if this type of document had been received by the system before. In one embodiment, the values in the document in a first format 200 are manually mapped and tagged to their semantic equivalent. In another embodiment, the mapping is performed automatically. Once the standard of the document in a first format 200 is determined, the mapping process takes place according to the determined standard. The parsed out semantically-tagged nodes are then output to the Database 220.

In a preferred embodiment, the Database 220 includes an Indexer 310 (which may be internal or external to the Database 220) and a Data Store 330. For semantically-tagged nodes to be stored in the Database 220, the Indexer 310 indexes the nodes by their semantic tag. Every node in every document is indexed. The indexed nodes are then stored in the Data Store 330 as information couplets. The information couplets each comprise a semantic tag name and a value that corresponds to the semantic tag name. For example, in reference to FIG. 5A, a tag name is po_number and the corresponding value is 999. Therefore, the information couplet comprises po_number and 999.

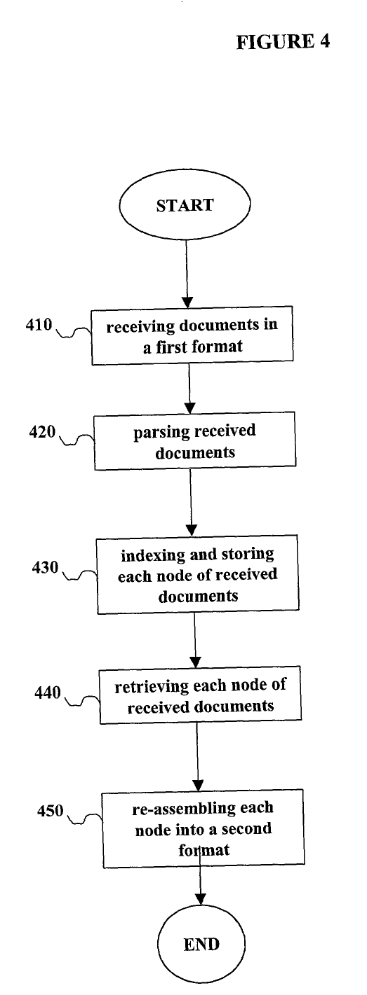

FIG. 4 describes a preferred embodiment of the operation of the present invention as discussed, for example, with respect to system components disclosed in FIGS. 2-3.

In step 410, the Data Translator 210 receives the document in a first format 200. In step 420, in the Data Translator 210, the received documents are parsed in accordance with the map, by the Parser 300, to create nodes. Each node is semantically-tagged.

In step 430, each semantically-tagged node set of the received document in the first format 200 is indexed by the Indexer 310 and stored in a Data Store 330.

In step 440, the semantically-tagged node sets that are indexed and stored are retrieved by the Data Translator 210. In step 450, each semantically-tagged node set of the document is reassembled and translated into a document in a second format 230, the second format being the target format.

The node sets are reassembled and translated into a document in a second format 230 according to the receiving endpoint (trading partner). The translator will reassemble the appropriate node sets depending on the receiving endpoint, because each endpoint specifies their own particular format and requires certain node sets to be reassembled for their particular format.

In order to accomplish the reassembling of the certain node sets, a mapping of the appropriate node sets to a document in a second format, i.e., a target format, must be performed. In one embodiment, the node sets are manually mapped to a document in a second format. In another embodiment, the mapping is performed automatically. This may be done for a new receiving endpoint or may have been done previously if this receiving endpoint has retrieved documents in the network before.

FIGS. 5A and 5B show a working example of a preferred embodiment of the present invention. It should be understood that the working example is intended to illustrate and not limit the present invention. FIG. 5A is a diagram showing an example of a preferred embodiment of the method of translating a document in a first format into a canonical format. FIG. 5B is a diagram showing an example of a preferred embodiment of the method of translating a document from semantically-tagged node sets to a document in a second format.

Referring to FIG. 5A, a document in a first format 510 includes four specific items: a po_number 550, a po_date 552, a quantity 554, and a product_id 556. These items are specifically highlighted in the document in a first format 510 in FIG. 5A for purposes of illustration. One skilled in the art would recognize these four items are representative of items in a possible transaction between trading partners. Various other transactions and items therein would be recognized by those skilled in the art.

In this preferred embodiment, the Canonical form 520 is in an eXtensible MarkUp Language (XML) format. However, one skilled in the art would recognize that the canonical form can be any other appropriate format, so that XML is not limiting in this example. The four specified values are semantically-tagged with appropriate tags that label the values written in the document in a first format 510.

A user of the data translation system or the system itself maps the nodes in the document in a first format 510 to its equivalent canonical node format. The semantic tag of the canonical form, i.e., po_number 550, is applied to the node set parsed from the document in a first format 510 that has an equivalent semantic value.

In the example of FIGS. 5A and 5B, the document in a first format 510 is in an EDI format, X12 standard. In the EDI format, the EDI standard, i.e. X12, EDIFACT, etc., determines which items are values that correspond to semantic tags, and a qualifier indicates which value is expressed. One skilled in the art would know that the format of the document in a first format 510 does not have to be EDI. The format of the document may be XML, comma-delimited, or any other suitable format. Similarly, the format of a document in a second format 540 can be in any other suitable format as well.

Referring now to FIG. 5B, the node set tags 530 are po_number 650, po_date 652, quantity 654, and product_id 656 are placed in the format of the second document 540. The nodes 530 are in the form of information couplets, wherein the couplet comprises the tag name and the value corresponding to that tag name. For example, for the tag name “quantity,” the value is 10. These node sets 530 are stored as information couplets in the Data Store 330, which is in the Database 220.

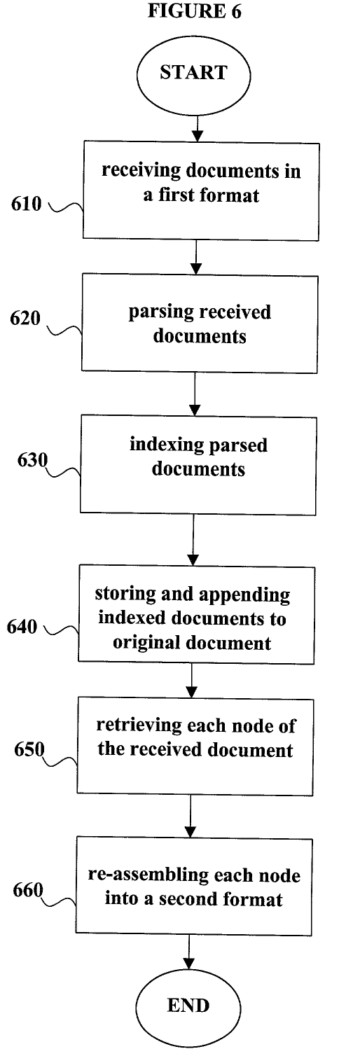

FIG. 6 describes a preferred embodiment of another operation of the present invention, as discussed, for example, with respect to system components disclosed in FIGS. 2-3.

In step 610, the Data Translator 210 receives the document in a first format 200, which is essentially an update to a document previously stored in the Data Store 330. In step 620, in the Data Translator 210, the received document is parsed in accordance with the map, by the Parser 300, to create nodes. Each node is semantically-tagged. The original document that it is updating is identified via a tag, line of code or other convenient reference.

In step 630, each semantically-tagged node set of the received document in the first format 200 is indexed by the Indexer 310.

In step 640, the updating document that has been parsed, semantically-tagged and indexed is stored in a Data Store 330 with the document previously stored in the Data Store 330. The document originally stored in the Data Store 330 is updated and altered by the updating document.

If the updating document contains new nodes not parsed in the original document, then the new nodes in the updating document are appended to the original document. If the updating document is altering and updating nodes of the original document, then the original document is altered by the updating document.

For node sets that correspond to node sets in the original document, a method at the endpoint creates a command message that indicates a path to the node sets of the original document that are to be updated. The path to the node sets of the original document is part of the command message sent to the GCN by the sending endpoint (i.e. trading partner). Once these node sets are located, they are overwritten with the node sets of the updating document. Thus, the original document has been updated and altered.

In step 650, registered endpoints that have received a notice of an event that a new updating document has been stored in the Data Store 330 may now retrieve each node set of the received document.

In step 660, each semantically-tagged node set of the document is reassembled and translated into a document in a second format 230, the second format being the target format.

The present invention provides a system where a data translator parses documents. The documents are parsed by the Parser 300 and the identified nodes semantically-tagged by the translator which passes the nodes to the Database 220 to be indexed and stored. The parsed nodes are then stored as semantically-tagged information couplets, where every node is indexed by the semantic tag and stored. The Data Store 330 allows for storage of semantically-tagged information couplets, as required by the invention, and allows indexing and querying on individual node sets.

Upon document retrieval, the required information couplets are retrieved from the Data Store 330 by individual queries within the Data Translator 210 and reassembled into the determined target document format. The determined target format is specified by the receiving endpoint by executing a “lookup” of the document type. In the “lookup” process, depending on the document type of the target format, a determination of the required information couplets is made. The required nodes are reassembled into the form of the target document.

Another feature of the present invention is “semantic-tagging.” The “tagging” of the information couplets follow a global data dictionary or taxonomy. This allows for indexing and retrievals of node sets by a common semantic distinction so that any source document format can be transformed into a target document by the intersection of the common semantic distinctions. This results in a “universal translation” capability, which allows trading partners to interact regardless of which data format they use.

It is a further feature of the present invention that inserts and updates to the GDS result in the triggering of events that are propagated throughout the GCN to the registered partners, i.e., endpoints, of the transaction. This allows for a push model of automatic updating of trading partner applications. In this model, the endpoints that registered to receive specific events can configure actions to the received events that allow retrieval of the updated data in the GDS and updating local systems with the data retrieved. For example, a trading partner sends out a purchase order. A third party carrier posts a shipping notice. The posting of the shipping notice is an event that is monitored by the original trading partner that sent out the purchase order. This originating trading partner may configure actions to update the status in its own system or generate an invoice based on the shipment, for example, based on this event trigger. This provides immediate and automatic visibility of changes made in the shipment.

There are several advantages as a result of the present invention. Documents may be stored in a common form and re-constructed into any desired target document format. This allows for an easy exchange of transactions between various trading partners and third parties, regardless of the internal format used by the individual trading partner.

Another advantage of the present invention is that queries may be performed on the document information couplets so that the represented transactions may be tracked. Other aggregations of data values may be performed to provide visibility to the state of the data and therefore the transactions within the Global Data Store (GDS).

Another advantage of the present invention is that events triggered by interaction with the GDS allow real-time, automatic updating of trading partner applications. For example, if a shipment notice on a purchase order is posted by a third-party carrier, the resulting event is monitored by the trading partner that originated the purchase order. The originating trading partner may update the status in its own system or generate an invoice based on the shipment, for example. This can provide automatic and immediate visibility of changes in shipments, production, schedules, and so on.

Other embodiments of the present invention will be apparent to those skilled in the art from a consideration of the specification and the practice of the invention disclosed herein. It is intended that the specification be considered as exemplary only, with the true scope and spirit of the invention being indicated by the following claims.

What is claimed is:

1. A computer implemented method of automatically storing and transmitting data in a network in an universal format, the method comprising the steps of:
receiving a document in a first format;
parsing said received document in said first format into constituent node sets; and
semantically-tagging, indexing and storing each node set of said received document in a data store.

2. The method according to claim 1, further comprising:
retrieving said each node set of said received document; and
reassembling required node sets of said received document into a second format.

3. The method according to claim 1, wherein said node sets comprise information couplets.

4. The method according to claim 1, wherein said node sets are stored in a data store.

5. The method according to claim 1, wherein said node sets are stored in a format that can be translated to substantially any other format.

6. The method according to claim 4, wherein said stored node sets are stored in a format corresponding to a format of said data store.

7. The method according to claim 1, further comprising triggering a propagation of a predetermined event to an endpoint of said network by the storing of a node set in said data store.

8. The method according to claim 7, wherein an endpoint in said network registers with said network for notification of said propagation of said predetermined event in said network.

9. The method according to claim 1, further comprising:
receiving a second document;
parsing said received second document into constituent node sets;
indexing said each node set of said received second document;
storing said each node set of said received second document in said data store; and
updating at least one of said node sets of said document previously stored in said data store which corresponds to one of said node sets of said received second document.

10. The method according to claim 9, further comprising triggering a propagation of an event to an endpoint of said network by the storing of at least one of said node sets of said second document and updating at least one of said node sets of said document previously stored in said data store.

11. The method according to claim 8, wherein said endpoint retrieves said node sets stored in said data store upon said notification of said predetermined event.

12. The method according to claim 1, further comprising:
receiving a second document;
parsing said received second document into constituent node sets;
indexing said each node set of said received second document;
storing said each node set of said received second document in said data store; and
appending at least one of said node sets of said received second document to said document previously stored in said data store.

13. The method according to claim 12, further comprising triggering a propagation of an event to an endpoint of said network by the storing or appending of at least one of said node sets of said second document stored in said data store.

14. A system for automatically storing and transmitting data in a network in an universal form, the system comprising:
a data translator that receives a document in a first format, said data translator comprising:
a parser that parses said received document into constituent node sets; and
a semantic tagging unit that semantically tags each said constituent node set;
an indexer that indexes said each node set; and
a data store that stores each said indexed node set.

15. The system according to claim 14, wherein said data translator retrieves each said indexed and stored node set and assembles said each node set into a second format.

16. The system according to claim 14, wherein said node sets are stored as information couplets.

17. The system according to claim 14, wherein said node sets are stored in a data store.

18. The system according to claim 14, wherein said stored node sets are stored in a format that can be translated to substantially any other format.

19. The system according to claim 17, wherein said stored node sets are stored in a format corresponding to a format of said data store.

20. A computer program product having program code that is executable by a computer for storing and transmitting data in a network in an universal form, the program code configured to cause the computer to perform the following steps:
receiving a document in a first format;
parsing said received document in said first format into constituent node sets; and
semantically-tagging, indexing and storing said each node set of said received document in a data store.

21. The program product according to claim 20, wherein the program code is configured to cause the computer to further perform the following step:
retrieving said each node set of said received document.

22. The program product according to claim 20, wherein the program code is configured to cause the computer to further perform the following steps:
retrieving said each node set of said received document; and
reassembling said each node set into a second format.

23. The program product according to claim 20, wherein said node sets are stored as information couplets.

24. The program product according to claim 20, wherein said node sets are stored in a data store.

25. The program product according to claim 20, wherein said stored node sets are stored in a format that can be translated to substantially any other format.

26. The program product according to claim 20, wherein said stored node sets are stored in a format corresponding to a format of said data store.

27. The method according to claim 20, further comprising triggering a propagation of a predetermined event to an endpoint of said network by the storing of a node set in said data store.

28. The method according to claim 27, wherein an endpoint in said network registers with said network for notification of said propagation of said predetermined event in said network.

29. The program product according to claim 20, further comprising:
receiving a second document;
parsing said received second document into constituent node sets;
indexing said each node set of said received second document;
storing said each node set of said received second document in said data store; and
updating at least one of said node sets of said document previously stored in said data store which corresponds to one of said node sets of said received second document.

30. The method according to claim 29, further comprising triggering a propagation of an event to an endpoint of said network by the storing of at least one of said node sets of said second document and updating at least one of said node sets of said document previously stored in said data store.

31. The method according to claim 28, wherein said endpoint retrieves said node sets stored in data store upon said notification of said predetermined event.

32. The program product according to claim 20, further comprising:
receiving a second document;
parsing said received second document into constituent node sets;
indexing said each node set of said received second document;
storing said each node set of said received second document in said data store; and
appending at least one of said node sets of said received second document to said document previously stored in said data store.

33. The method according to claim 32, further comprising triggering a propagation of an event to an endpoint of said network by the storing or appending of at least one of said node sets of said second document stored in said data store.

34. A computer implemented method of automatically storing and transmitting data in a network in an universal form comprising the steps of:
receiving a document in a first format;
parsing, semantically-tagging, storing, and indexing node sets of said received document in said first format; and
reassembling said each node set into a second format.

35. A system for automatically storing and transmitting data in a network in an universal form, the system comprising:
means for a receiving a document in a first format;
means for parsing said received document into constituent node sets;
means for semantically-tagging each said node set;
means for indexing said each node set; and
means for storing said each indexed node set.

36. A system according to claim 35, further comprising:
means for retrieving said each indexed and stored node set; and
means for assembling said each node set into a second format.
